(19) United States
(12) Patent Application Publication
(10) Pub. No.: US 2018/0252476 A1
(43) Pub. Date: Sep. 6, 2018

(54) THERMAL MANAGEMENT SYSTEM

(71) Applicant: BLACK TANK, LLC, Haverhill, MA (US)

(72) Inventors: Michael W. JOHNSON, Amesbury, MA (US); Douglas A. JOHNSON, Groveland, MA (US)

(21) Appl. No.: 15/909,340

(22) Filed: Mar. 1, 2018

Related U.S. Application Data
(60) Provisional application No. 62/465,966, filed on Mar. 2, 2017.

(51) Int. Cl. F28D 15/02; F28F 13/06; F28F 1/22; F21V 29/74

(52) U.S. Cl. CPC F28D 15/0275; F28F 13/06; F28D 2021/0029; F21V 29/74; F28F 1/22

(57) ABSTRACT

A thermal management system includes a heat sink configured to receive heat from a heat source, and an elongated, thermally-conductive member in thermal contact with the heat sink along a length of the heat sink such that a thermal gradient along the length of the heat sink is generally constant.

### CROSS-REFERENCE TO RELATED APPLICATIONS

This application claims the benefit of U.S. provisional application Ser. No. 62/465,966 filed Mar. 2, 2017, which is hereby incorporated by reference herein.

### TECHNICAL FIELD

The present disclosure relates to a thermal management system.

### BACKGROUND

An extruded heat sink with fins is able to remove heat from a device by heat transfer from the device to the heat sink and then by transfer of the heat from the heat sink to a cooling medium such as air or water, for example. Heat sinks of this type are most efficient—in terms of Watts of heat dissipated per unit area of the heat sink—when the temperature difference (ΔT) between the heat sink and the cooling medium is highest. A governing equation is: q=h_{c}AΔT, where (q) is the heat dissipated, (A) is the area of contact between the heat sink and the cooling medium, and (ΔT) is the temperature difference between the heat sink and the cooling medium.

In practice, if a power device is mounted on a heat sink having any appreciable length extending away from the heat source, the thermal performance or efficiency per unit area of the heat sink decreases as the distance from the heat source increases. This is because the temperature difference between the heat sink and the cooling medium decreases as the distance from the heat source increases. One way to mitigate this loss of efficiency is to use a heat sink that is made from a material having very high thermal conductivity, such as copper. Configuring the heat sink with a relatively large mass for a base, and short fins to minimize the distance from the heat source and increase the surface area of the heat sink, also helps to reduce the temperature difference and increase the overall heat dissipating efficiency. This approach tends to increase the cost and weight of the heat sink and has limited applicability. In situations where the heat source is an electronic device with a high power density—e.g., high-power LEDs in chip-on-board (COB) packages—the problem of moving heat away from the device, especially in directions transverse to convection currents, may be particularly difficult. Therefore, a need exists for a system and method for thermal management that overcomes some or all of the aforementioned limitations of current systems and methods for heat dissipation.

### SUMMARY

At least some embodiments described herein include a thermal management system that includes a heat sink configured to receive heat from a heat source, and a heat pipe in thermal contact with the heat sink along a length of the heat sink such that a thermal gradient along the length of the heat sink is generally constant.

At least some embodiments described herein include a thermal management system that includes a heat sink having a first portion configured to be disposed proximate to a heat source to receive heat from the heat source. The heat sink has a second portion extending away from the first portion, and is configured to transfer the heat received by the first portion: (i) along the second portion and (ii) away from the heat sink to an ambient environment around the heat sink. The heat transferred along the second portion creates a thermal gradient with the ambient environment. The thermal management system also includes a thermally conductive elongate member in contact with the heat sink along a length of the second portion such that the thermal gradient along the length of the second portion is generally constant. In at least some embodiments, the thermally conductive elongate member may be a heat pipe, and in other embodiments it may be a passive heat transfer element.

At least some embodiments described herein include a thermal management system including a heat sink having a first end in thermal contact with a heat source and a second end disposed away and detached from the heat source. A heat pipe is physically detached from the heat source and contacts the heat sink along at least a substantial length of the heat pipe. The heat pipe contacts the heat sink along a length of the heat sink between the first and second ends of the heat sink such that a thermal gradient along the length of the heat sink is generally constant.

At least some embodiments described herein include a thermal management system including a heat sink having a first portion configured to be disposed proximate to a heat source to receive heat from the heat source. The heat sink also has a second portion extending away from the first portion that is configured to transfer the heat received by the first portion along the second portion and away from the heat sink to an ambient environment around the heat sink. The heat transferred along the second portion defines a thermal gradient. A heat pipe is unconnected to the heat source and is in thermal contact with the heat sink along at least a substantial length of the heat pipe and along a length of the second portion such that the thermal gradient along the length of the second portion is generally constant. Having a heat pipe unconnected to the heat source provides the advantage of more evenly spreading the heat across the heat sink without the need to connect the heat pipe directly to the heat source.

At least some embodiments described herein include a thermal management system including an elongated heat sink having a first end in heat conductive attachment to a heat source and a second end disposed away from the heat source. The heat sink includes a plurality of fins disposed between the first end and the second end. A heat pipe is detached from the heat source and connected to the heat sink in a generally parallel orientation relative to the fins. The heat pipe contacts the heat sink along a length of the heat sink between the first end and the second end such that a thermal gradient along the length of the heat sink is generally constant.

### BRIEF DESCRIPTION OF THE DRAWINGS

FIG. 1 shows a partially schematic illustration of a thermal management system in accordance with embodiments described herein;

FIGS. 2A and 2B respectively show side and end views of a thermal management system in accordance with embodiments described herein;

FIG. 3 shows an end view of a portion of a thermal management system in accordance with embodiments described herein;

FIG. 4 shows an end view of a portion of a thermal management system in accordance with embodiments described herein;

FIG. 5 shows an end view of a portion of a thermal management system in accordance with embodiments described herein;

FIG. 6A shows an end view of a portion of a thermal management system in accordance with embodiments described herein;

FIG. 6B shows a side view of a portion of a heat sink used with the thermal management system shown in FIG. 6A;

FIG. 7A shows an end view of a portion of a thermal management system in accordance with embodiments described herein;

FIG. 7B shows a side view of a portion of a heat sink used with the thermal management system shown in FIG. 7A;

FIG. 8A shows an end view of a portion of a thermal management system in accordance with embodiments described herein;

FIG. 8B shows a side view of a portion of a heat sink used with the thermal management system shown in FIG. 8A;

FIG. 9A shows an end view of a portion of a thermal management system in accordance with embodiments described herein;

FIG. 9B shows a side view of a portion of a heat sink used with the thermal management system shown in FIG. 9A;

FIG. 10A shows an end view of a portion of a thermal management system in accordance with embodiments described herein;

FIG. 10B shows a side view of a portion of a heat sink used with the thermal management system shown in FIG. 10A;

FIG. 11A shows an end view of a portion of a thermal management system in accordance with embodiments described herein; and

FIG. 11B shows a side view of a portion of a heat sink used with the thermal management system shown in FIG. 11A.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

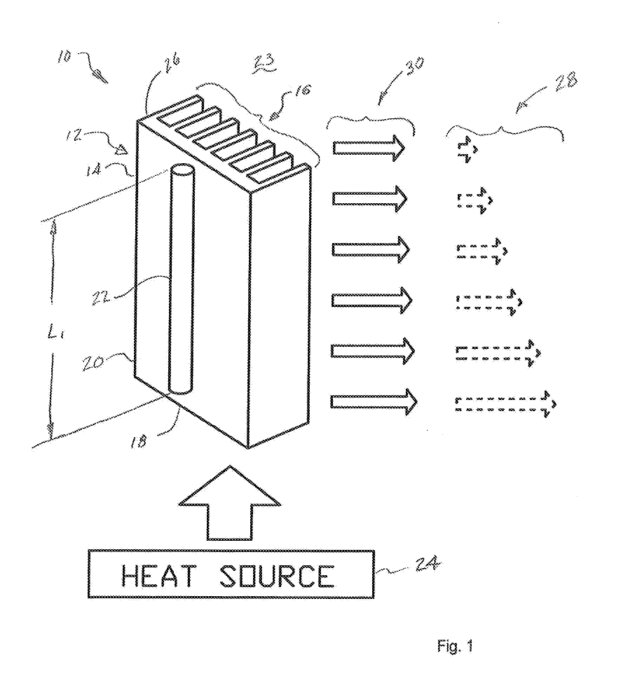

FIG. 1 shows a thermal management system 10 in accordance with embodiments described herein. The thermal management system 10 includes a heat sink 12 having a base 14 and a plurality of fins 16. The heat sink 12 includes a first portion, which in this embodiment is a first end 18 of the generally rectangular heat sink 12. The heat sink 12 also includes a second portion 20, which in this embodiment is defined as the rest of the heat sink 12 that extends away from the end 18. A thermally conductive elongate member 22 is in contact with the heat sink 12 along a length (L₁) of the second portion 20, and in this embodiment is oriented generally parallel to the fins 16. The heat sink 12 is disposed proximate to a heat source 24, which may be any number of different devices. As described herein, various embodiments may be particularly well-suited for use with electronic components and devices such as LEDs and power electronics, or to integrate into existing products for which the thermal design—for example, the design of the heat source, heat sink, etc.—is fixed and not easily modified, but may benefit from additional thermal performance. In addition, even though the heat source 24 is illustrated in FIG. 1 as not being in direct contact with the heat sink 12, it is in thermal contact with the heat sink 12, and in other configurations there may be physical contact between a heat sink and a heat source.

In the embodiment illustrated in FIG. 1, the thermally conductive elongate member 22 is a heat pipe. The heat pipe 22 contacts the heat sink 12 along its entire length (L₁), though in other embodiments, it may contact a heat sink along a substantial portion of its length only—e.g., more than 50% of its length. In other embodiments, a heat pipe may contact a heat sink along a substantial length of the heat pipe that is, for example, 60-90% of its length. Heat pipes are known in the art, and rely on an internal convection mechanism to transfer heat. In at least some heat pipes, an inner portion of a heat pipe includes a wick-like capillary material and a heat transfer fluid. At the end of a heat pipe near a heat source, the fluid absorbs heat by vaporizing and then releases heat at the other end of the heat pipe when the vapor condenses.

Positioning the heat pipe 22 as shown in FIG. 1—i.e., in thermal contact with the heat sink 12—provides a significant efficiency advantage over a heat sink that does not include a heat pipe or other thermally conductive elongate member. Without the use of the heat pipe 22, the second portion 20 of the heat sink 12 would have a widely varying thermal gradient with an ambient environment 23 around the heat sink 12. Because the end 18 near the heat source 24 would be the warmest, and a second end 26 of the heat sink 12, opposite the first end 18, would be the coolest, the thermal gradient would be greatest near the first end 18 and much smaller near the second end 26—assuming, of course, a generally constant ambient air temperature and velocity along the length (L₁).

A thermal gradient occurring without the use of the heat pipe 22 is shown schematically by the dashed arrows 28. In contrast, the configuration shown in FIG. 1, which does include the heat pipe 22 along the length (L₁) of the second portion 20, makes the thermal gradient much more constant. This is illustrated by the arrows 30 shown in FIG. 1. Although the thermal gradient may not be perfectly constant—i.e., it may be somewhat larger near the heat source 24 than at the opposite end 26—the thermal management system 10 provides for a generally constant thermal gradient. As used herein, a “generally constant” thermal gradient is one that does not vary by more than 10%, although with some embodiments, and depending on the application, the variation may be 5% or less. In some embodiments, the difference in the thermal gradient of a heat sink along the length where it is connected to a heat pipe may be so little as to be difficult or impossible to measure. An efficiency gain can be realized by placing the heat pipe in thermal contact with the heat sink even when the heat pipe is detached from the heat source such as shown in FIG. 1.

FIG. 2A shows a thermal management system 32 in accordance with embodiments described herein. The thermal management system 32 includes a thermally-conductive base 34, which may be made from, for example, copper or some other highly thermally-conductive material. Attached to the base 34 are four heat pipes 36, 38, 40, 42. The heat pipes 36, 38, 40, 42 may be attached to the base 34 in any convenient manner that allows for heat transfer between the base 34 and the heat pipes 36, 38, 40, 42. For example, the heat pipes 36, 38, 40, 42 may be press-fit into holes in the base 34, or they may be fitted loosely into the holes and secured with a thermally-conductive solder or other adhesive.

In contact with the heat pipes 36, 38, 40, 42 are four heat sinks 44, 46, 48, 50, respectively—see also FIG. 2B. The base 34, the heat pipes 36, 38, 40, 42, and the heat sinks 44, 46, 48, 50 are all disposed at least partially within a housing or canister 52. Shown in phantom in FIG. 2A—but not shown in FIG. 2B—is a heat source 54, which may be, for example, an electronic device such as a high-power COB LED. The heat source 54 may be attached to the base 34, for example, by a thermally-conductive adhesive or by any other way effective to allow heat to transfer from the heat source 54 to the base 34. An LED reflector optic 55 may also be attached at the base 34. In the embodiment shown in FIG. 2A, the heat pipes 36, 38, 40, 42 are attached to the base 34, which is in direct contact with the heat source 54. In contrast, the heat sinks 44, 46, 48, 50 do not directly contact the heat source 54. In other embodiments, the reverse may be true: the heat sinks may be in physical contact with a heat source, while the associated heat pipes contact only the heatsinks and not the heat source—see, e.g., FIG. 1.

In the embodiment shown in FIGS. 2A and 2B, the heat sinks 44, 46, 48, 50 are extruded aluminum, each having a base and a plurality of fins. At one end of each of the bases of the heat sinks 44, 46, 48, 50 is a generally cylindrical connector 56, 58, 60, 62, respectively. The connectors 56, 58, 60, 62 are configured to be inserted into mating receiving portions 64, 66, 68, 70, which are formed as part of the extruded canister 52. More specifically, the heat sinks 44, 46, 48, 50 are attached to a housing wall 71 of the housing 52 with a pivotable attachment toward one side of each of the heat sinks 44, 46, 48, 50. This configuration allows each of the heat sinks 44, 46, 48, 50 to pivot around its respective connector 56, 58, 60, 62 and to capture the corresponding heat pipe 36, 38, 40, 42 between its heat sink 44, 46, 48, 50 and an inside surface 72 of the wall 71. Once the heat pipes 36, 38, 40, 42 are pushed against the inside surface 72, pins 74, 76, 78, 80 can be placed between a second end of the bases of the heat sinks 44, 46, 48, 50 and hook portions 82, 84, 86, 88 which are also extruded into the canister 52; this provides a selectively fixed attachment toward the other sides of the heat sinks 44, 46, 48, 50.

With the configuration of the thermal management system 32 illustrated in FIGS. 2A and 2B, the heat pipes 36, 38, 40, 42 serve at least two purposes. First, they transfer heat away from the base 34—and ultimately the heat source 54—because they contact the base 34, and second, they reduce or eliminate the temperature differences along the lengths (L₂) of the heat sinks 44, 46, 48, 50 because they contact the heat sinks 44, 46, 48, 50. The thermal management system 32 transfers heat from the heat source 54 by several mechanisms. First, heat is transferred to the base 34 and then away from the base 34 by the heat pipes 36, 38, 40, 42. Heat is also transferred from the base 34 to the heat sinks 44, 46, 48, 50; this may be by convection, conduction, radiation, or some combination of the three. Heat is transferred from the heat sinks 44, 46, 48, 52 to an ambient environment around the thermal management system 32, which in this example, is ambient air. In other embodiments different cooling media may be used, such as a liquid, a gas other than air, or some other fluid, just to name a few. The canister 52 also receives heat from the heat pipes 36, 38, 40, 42, and may also receive heat directly from the heat sinks 44, 46, 48, 50, the base 34, and even the heat source 54. The canister 52 then transfers heat to the ambient environment similar to the heat sinks 44, 46, 48, 50.

Without the use of the heat pipes 36, 38, 40, 42, the heat sinks 44, 46, 48, 50 would be much warmer at their respective ends closest to the base 34 and much cooler at their respective ends away from the base 34. Using the heat sink 46 as an example, it has one end 88 close to the base 34 and another end 90 disposed away from the base 34. The two ends 88, 90 define the length (L₂). Because the heat pipe 38 is forcefully captured between the heat sink 46 and the inside surface 72 of the canister 52, there is good heat transfer between the heat pipe 38 and the heat sink 46. Therefore, just as the heat pipe 38 is able to move heat away from the base 34 because of its internal convection heat transfer mechanism, which may include a liquid phase change, the heat pipe 38 is also able to move heat away from the warmer end 88 of the heat sink 46 and transfer it to the cooler end 90. This helps to ensure a generally constant thermal gradient over the length (L₂) of the heat sink 46; this also occurs for the other heat sinks 44, 48, 50 and their respective heat pipes 36, 40, 42.

Various embodiments of thermal management systems may have configurations different from the one described above with reference to FIGS. 2A and 2B. For example, in some configurations, a thermal management system may have one or more heat sinks in direct contact with the heat source or a base, such as the base 34, that is itself in direct contact with the heat source. Heat pipes may then be used to reduce or eliminate temperature differences along length of the heat sinks to make the thermal gradient with the cooling medium generally constant. In some embodiments, a highly thermally-conductive member may be used in place of a heat pipe. With this configuration, there may still be conductive heat transfer between the thermally-conductive member and the heat sink just as with a heat pipe; however, without the internal convection process employed by a heat pipe, heat would be transferred along a length of the thermally-conductive member at least primarily by conduction, rather than internal convection.

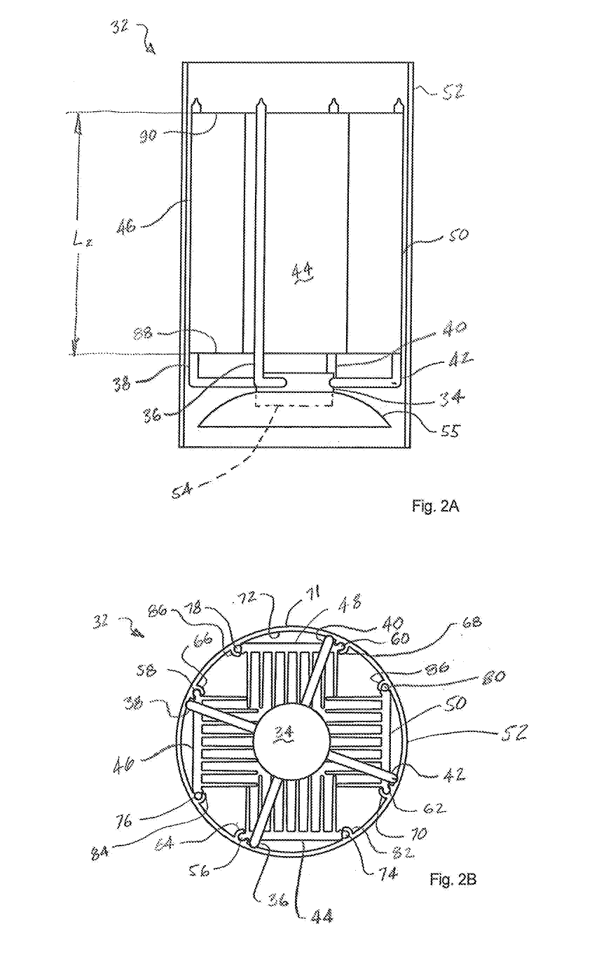

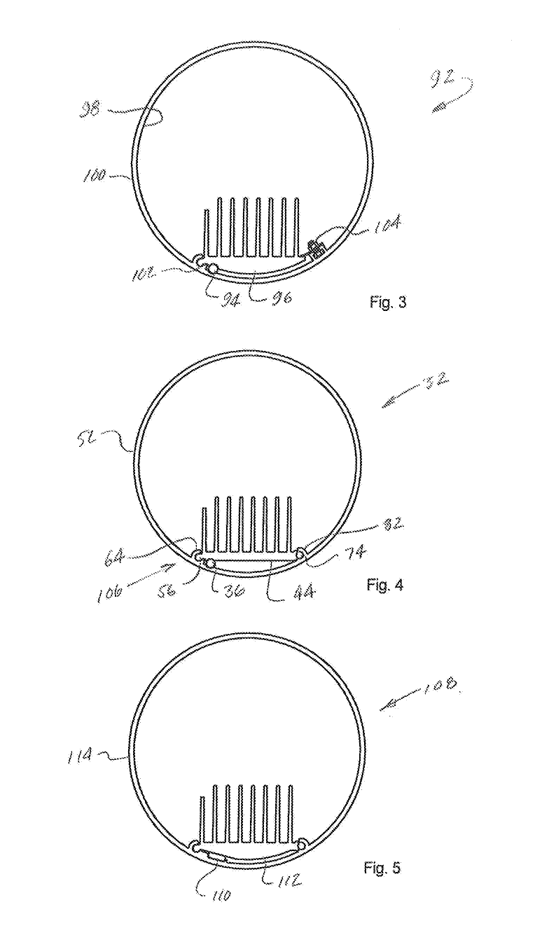

FIG. 3 shows an end view of a portion of a thermal management system 92 in accordance with embodiments described herein. In this embodiment, a heat pipe 94 is captured between a heat sink 96 and an inside surface 98 of the canister 100. The heat sink 96 is hinged at one and 102 such as described above with regard to the thermal management system 32; however, at the other end of the heat sink 96 a biasing member, which in this embodiment is a fastener arrangement having a threaded fastener 104, is used to hold the heat sink 96 tightly against the heat pipe 94. This configuration has the advantage of being able to adjust the amount of force that is placed on the heat pipe 94, and more specifically, the force of contact between the heat sink 96 and the heat pipe 94. FIG. 4 shows a portion of the thermal management system 32 described in detail above with regard to FIGS. 2A and 2B. The connector 56 and the mating receiving portion 64 of the canister 52 form a hinge 106 that allows the heat sink 44 to pivot so as to firmly capture the heat pipe 36. The heat sink 44 is then secured with the pin 74 and the hook portion 82. In the embodiment shown in FIG. 5, a portion of the thermal management system 108 includes a heat pipe 110 captured between a heat sink 112 and a canister 114. In this embodiment, the heat pipe 110 has a generally rectangular cross section, rather than a round cross section.

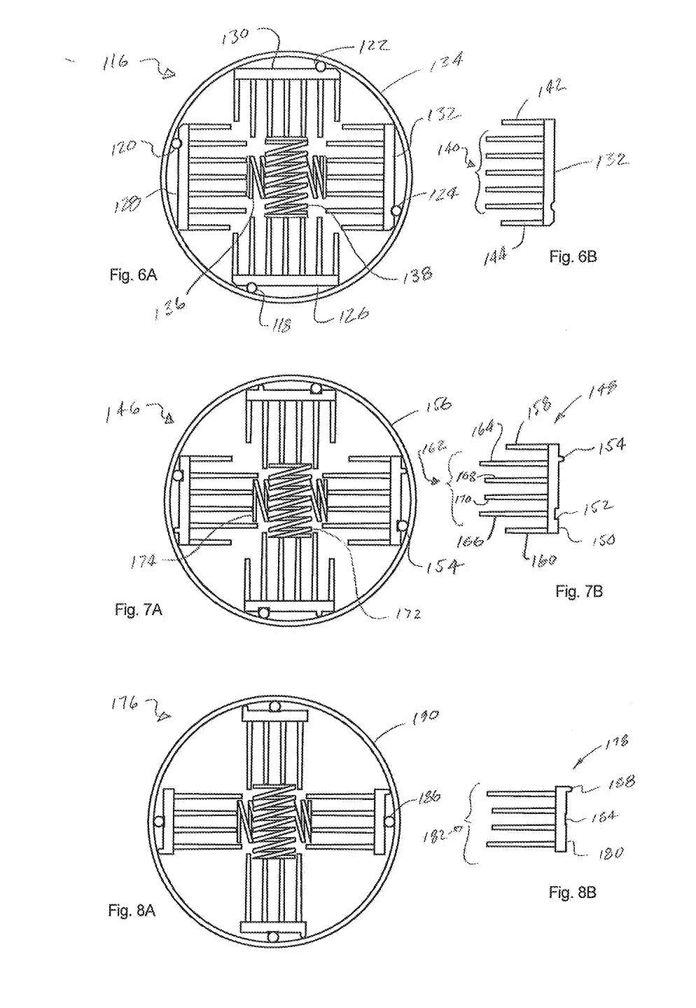

FIG. 6A shows a portion of a thermal management system 116 in accordance with embodiments described herein. Similar to the configurations described above, the thermal management system 116 includes four heat pipes 118, 120, 122, 124, each of which is captured between a respective heat sink 126, 128, 130, 132 and a housing or canister 134. In the embodiment shown in FIG. 6A, the heat sinks 126, 128, 130, 132 are not attached to the canister by hinges and pins such as described above; rather, they maintain contact with their respective heat pipes 118, 120, 122, 124 because of biasing members, which in this embodiment are compression springs 136, 138 positioned between opposite pairs of the heat sinks 126, 128, 130, 132. FIG. 6B shows one of the heat sinks 132 removed from the canister 134. To accommodate the compression springs 136, 138, the heat sink 132 includes fins 140 having the same length over a middle portion of the heat sink 132 so as to provide a flat surface for the end of the spring 136. In contrast, fins 142, 144 on the ends of the heat sink 132 are shorter, which accommodates fitting the four heat sinks 126, 128, 130, 132 together inside the canister 134 as shown in FIG. 6A. Using springs, such as the springs 136, 138, helps to keep a constant force applied to the heat pipes 118, 120, 122, 124 even when they, or other portions of the thermal management system 116, deform over extended use.

FIG. 7A shows a portion of the thermal management system 146 in accordance with embodiments described herein. Of particular note here is the configuration of the four heat sinks, one of which, heat sink 148, is shown isolated in FIG. 7B. The heat sink 148 includes a base 150 having a notch 152 to accommodate a heat pipe 154—see FIG. 7A. The base 150 also includes a foot 152 that helps to keep the heat sink 148 stable within a canister 156. Similar to the heat sink 132 shown in FIG. 6B, the heat sink 148 includes end fins 158, 160, which are shorter than the fins toward the middle of the heat sink 148. Different from the heat sink 132, however, is the configuration of the center fins 162, which include two longer fins 164, 166 on the outside and two shorter fins 168, 170 toward the center. As shown in FIG. 7A, the fins 164, 166, 168, 170—and the fins on the other heat sinks—are configured to receive the springs 172, 174 in a nesting arrangement, which may help to stabilize the springs 172, 174 when the heat sinks are installed in the housing 156.

FIG. 8A shows a portion of the thermal management system 176 having a variation on the heat sink configuration shown in FIG. 7A and 7B. FIG. 8B shows a heat sink 178 having a base 180 and fins 182. The fins 182 are similarly configured to the fins 164, 166, 168, 170 shown in FIG. 7B; however, the heat sink 178 does not have the shorter end fins such as 158, 160. The base 180 of the heat sink 178 also includes a notch 184 to accommodate a heat pipe 186, and a foot 188 to help stabilize the heat sink 178 when it is installed in a canister 190.

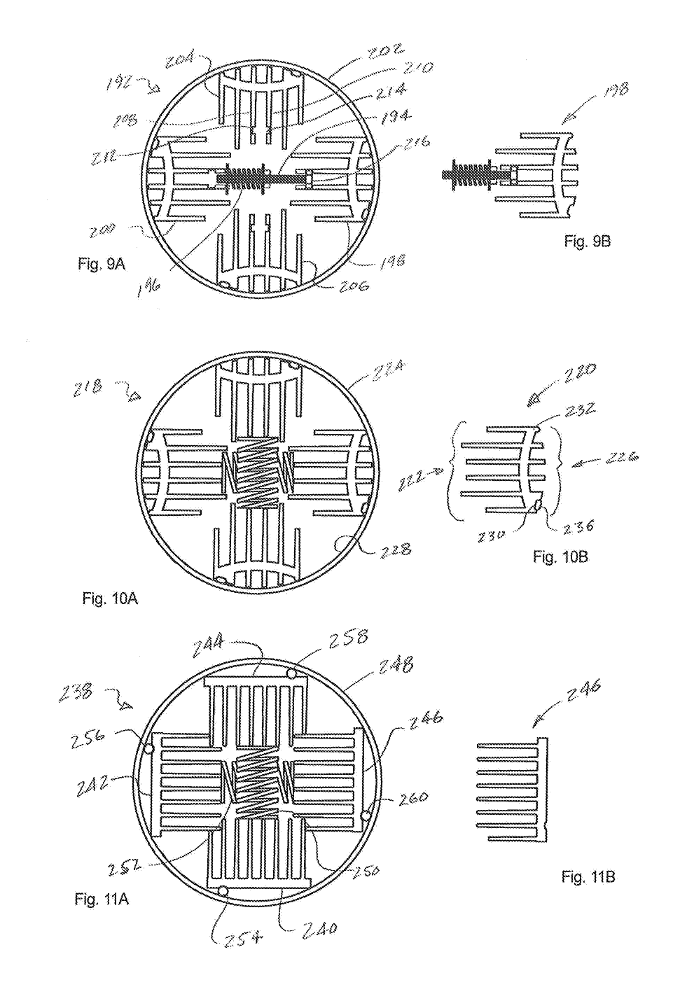

FIGS. 9-11 show variations on the heat sink and canister configurations described above. For example, FIG. 9A shows a portion of a thermal management system 192 that utilizes a biasing member, which in this embodiment includes a fastener arrangement having a threaded fastener 194 in conjunction with a compression spring 196 to maintain contact between heat sinks 198, 200 and a canister 202. Although not shown, it is understood that a similar fastener and spring configuration is used for the other two heat sinks 204, 206. As shown, for example, in the heat sink 204, center fins 208, 210 each include a respective notch 212, 214 to accommodate a head 216 of the threaded fastener 194. FIG. 10A shows a portion of the thermal management system 218 that includes heat sinks configured as the heat sink 220 shown in FIG. 10B. The heat sink 220 includes fins 222 directed toward an inside of the canister 224, and also includes fins 226 directed toward an outside of the canister 224. The ends of the fins 226 define a generally arcuate line so as to make good contact with a circular inside surface 228 of the canister 224. A notch 230 in a base 232 of the heat sink 220 accommodates a heat pipe 236 having a generally elliptical cross section. FIG. 11 a shows a portion of a thermal management system 238 in which heat sinks 240, 242, 244, 246 are held in place in a canister 248 by compression springs 250, 252. The compression springs 250, 252 help to keep a force applied to heat pipes 254, 256, 258, 260 to help facilitate heat transfer between them and their respective heat sinks 240, 242, 244, 246, as well as heat transfer to the canister 248.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A thermal management system, comprising:
a heat sink having a first portion in thermal contact with a heat source and a second portion disposed away and detached from the heat source; and
a heat pipe physically detached from the heat source and contacting the heat sink along at least a substantial length of the heat pipe, the heat pipe contacting the heat sink along a length of the heat sink between the first and second portions of the heat sink such that a thermal gradient along the length of the heat sink is generally constant.

2. The thermal management system of claim 1, further comprising a housing having a housing wall with an inside surface and containing at least a portion of the heat sink, the heat pipe being captured between the heat sink and the inside surface of the housing wall such that heat is transferred between the heat pipe and the heat sink and between the heat pipe and housing wall.

3. The thermal management system of claim 2, wherein the heat sink is attached to the housing wall at a pivotable attachment toward one side of the heat sink and a selectively fixed attachment toward another side of the heat sink.

4. The thermal management system of claim 2, further comprising a biasing member positioned to apply a force to the heat sink in a direction of the heat pipe to increase a force of contact between the heat sink and the heat pipe.

5. The thermal management system of claim 4, wherein the heat sink is attached to the housing wall at a pivotable attachment and the biasing member includes a fastener arrangement operable to pivot the heat sink around the pivotable attachment and toward the heat pipe.

6. The thermal management system of claim 4, wherein the heat sink includes a plurality of fins configured to exchange heat from the heat sink with an ambient environment surrounding the heat sink, and the biasing member includes a compression spring in contact with at least one of the fins, the fins being further configured to receive the compression spring in a nesting arrangement to facilitate the contact between the spring and the at least one of the fins.

7. The thermal management system of claim 4, wherein the biasing member includes a fastener arrangement operable to increase the force applied to the heat sink in the direction of the heat pipe.

8. The thermal management system of claim 7, wherein the heat sink is a first heat sink and the heat pipe is a first heat pipe, the system further comprising a second heat sink having a first portion in thermal contact with the heat source and a second portion disposed away and detached from the heat source; and
a second heat pipe physically detached from the heat source and contacting the second heat sink along at least a substantial length of the second heat pipe, the second heat pipe contacting the second heat sink along a length of the second heat sink between the first and second portions of the second heat sink such that a thermal gradient along the length of the second heat sink is generally constant, and
wherein the fastener arrangement includes a threaded fastener and a spring disposed between the first and second heat sinks and operable to apply a force to each of the first and second heat sinks in the respective directions of the first and second heat pipes.

9. A thermal management system comprising:
a heat sink having a first portion configured to be disposed proximate to a heat source to receive heat from the heat source, the heat sink having a second portion extending away from the first portion and configured to transfer the heat received by the first portion along the second portion and away from the heat sink to an ambient environment around the heat sink, the heat transferred along the second portion defining a thermal gradient; and
a heat pipe unconnected to the heat source and in thermal contact with the heat sink along at least a substantial length of the heat pipe and along a length of the second portion such that the thermal gradient along the length of the second portion is generally constant.

10. The thermal management system of claim 9, wherein the heat pipe is connected to and in contact with the heat sink along an entire length of the heat pipe.

11. The thermal management system of claim 9, wherein the heat pipe is in thermal contact with the heat sink such that the thermal gradient along the length of the second portion varies by no more than 10%.

12. The thermal management system of claim 9, wherein the heat pipe is in thermal contact with the heat sink such that the thermal gradient along the length of the second portion varies by no more than 5%.

13. The thermal management system of claim 9, further comprising a housing having a housing wall with an inside surface and containing at least a portion of the heat sink, the heat pipe being captured between the heat sink and the inside surface of the housing wall.

14. The thermal management system of claim 13, wherein the heat sink is attached to the housing wall at a pivotable attachment toward one side of the heat sink and a selectively fixed attachment toward another side of the heat sink.

15. The thermal management system of claim 13, further comprising a biasing member positioned to apply a force to the heat sink in a direction of the heat pipe to increase a force of contact between the heat sink and the heat pipe.

16. The thermal management system of claim 15, wherein the heat sink includes a plurality of fins configured to exchange heat from the heat sink with the ambient environment around the heat sink, and the biasing member includes a compression spring in contact with at least one of the fins, the fins being further configured to receive the compression spring in a nesting arrangement to facilitate the contact between the spring and the at least one of the fins.

17. A thermal management system, comprising:
an elongated heat sink having a first end in heat conductive attachment to a heat source and a second end disposed away from the heat source, and including a plurality of fins disposed between the first end and the second end; and
a heat pipe detached from the heat source and connected to the heat sink, the heat pipe contacting the heat sink along a length of the heat sink between the first end and the second end such that a thermal gradient along the length of the heat sink is generally constant.

18. The thermal management system of claim 17, wherein the heat pipe is disposed in a generally parallel orientation relative to the fins.

19. The thermal management system of claim 17, further comprising a housing having a housing wall with an inside surface and containing at least a portion of the heat sink, the heat pipe being captured between the heat sink and the inside surface of the housing wall.

20. The thermal management system of claim 19, further comprising a biasing member positioned to urge the heat sink toward the housing wall to increase a force of contact between the heat sink and the heat pipe.
